(19) United States
(12) Patent Application Publication
(10) Pub. No.: US 2014/0365469 A1
(43) Pub. Date: Dec. 11, 2014

(54) USER ADDRESS BOOK DATA MANAGEMENT SYSTEM

(71) Applicants: Steven Daskal, Lyndhurst, OH (US); Paul Dietzen, Northfield, OH (US); Jeanette Webster, Sagamore Hills, OH (US); Drew Mayer, Shaker Heights, OH (US); Russell Francis, Cleveland, OH (US)

(72) Inventors: Steven Daskal, Lyndhurst, OH (US); Paul Dietzen, Northfield, OH (US); Jeanette Webster, Sagamore Hills, OH (US); Drew Mayer, Shaker Heights, OH (US); Russell Francis, Cleveland, OH (US)

(73) Assignee: CONTACTREV LLC, Lyndhurst, OH (US)

(21) Appl. No.: 14/298,293

(22) Filed: Jun. 6, 2014

Related U.S. Application Data
(60) Provisional application No. 61/832,134, filed on Jun. 6, 2013.

(51) Int. Cl. G06F 17/30; H04L 29/08

(52) U.S. Cl. CPC G06F 17/30598; G06F 17/30424; H04L 67/10
USPC 707/722; 707/740

(57) ABSTRACT

One or more techniques or systems are disclosed for allowing a first user to control what information is available to other users in the first user's address book on an address book system. A first user can import user contacts from one or more devices into the first user's address book in an address book system. The first user can enter additional contact information data into the first user's address book and edit preferences for other users to view selected portions of the entered contact information. The first user may subsequently identify a second user of the address book system and make a connection with the second user. The first user can edit access preferences for the second user, with regards to the second user accessing the first user's contact information.

### CROSS-REFERENCE TO RELATED APPLICATIONS

This application claims the benefit of U.S. Provisional Application No. 61/832,134, titled User Address Book Data Management, filed Jun. 6, 2013, which is herein incorporated by reference.

### BACKGROUND

Users of smart devices, mobile devices, laptops, tablets, PCs, etc. may have one or more sets of contact information linked to respective devices, applications, or online services. Often, users connect to other users online via one or more of these devices, applications or online services, sometimes allowing the connections to access personal contact information about the user. Contacts or connections are often stored in address books, linked to local or remote databases that store respective contact information.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, one or more techniques or systems may be devised that can allow a user to control what information is available to other users in their address books on a proprietary online-based account platform. In one implementation, a first user can import first user mobile device-based contacts into a platform-based address book linked database. Further, the first user can enter one or more first user contact information data into the platform-based address book linked database, which is associated with the first user. Additionally, the first user can identify a second user of the platform-based address book linked database. The first user may also connect with the second user using the platform-based address book linked database. The first user can then edit access preferences for the second user, for access to one or more data of the one or more first user contact information.

According to some implementations, a computer implemented method for managing personal contact information between connected users of an address book system may include one or more of the following steps: adding a first user's contact information to a first address book in an address book database; adding a second user's contact information to a second address book in the address book database; selecting a first subset of the first user's contact information in the first address book to share with a second user; receiving data indicative of a connection request being sent from the first user to the second user; selecting a second subset of the second user's contact information in the second address book to share with the first user; receiving data indicative of an acceptance of the connection request by the second user; adding the first subset of the first user's contact information from the first address book to the first user's contact information in the second address book; and adding the second subset of second user's contact information to the second user's contact information in the first address book.

According to some implementations, a system for managing user contact information may include one or more processors, a system memory, and one or more computer storage devices having stored thereon a database having a first address book and a second address book. The first address book may include first address information for a first user, and the second address book includes a subset of the first address information. When the subset of first address information is updated in the first address book, the system may update the subset of the first address information in the second address book.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a flow diagram illustrating an exemplary method for controlling access to personal contact information between connected users of an online-based network, according to some implementations.

FIG. 2 illustrates an exemplary implementation of a computer-readable medium, according to some implementations.

FIG. 3 illustrates an exemplary operating environment, according to some implementations.

FIG. 4 is a schematic diagram illustrating an exemplary operating environment, according to some implementations.

FIG. 5A is a flow diagram illustrating an exemplary method for managing personal contact information between connected users of an address book system, according to some implementations.

FIG. 5B is a flow diagram illustrating an exemplary method for managing personal contact information between connected users of an address book system, according to some implementations.

FIG. 5C is a flow diagram illustrating an exemplary method for managing personal contact information between connected users of an address book system, according to some implementations.

FIG. 6 is a diagram illustrating an exemplary listing of contacts, according to some implementations.

FIG. 7 is a flow diagram illustrating an exemplary method for adding multiple contacts to an address book system, according to some implementations.

FIG. 8 is a flow diagram illustrating an exemplary method for sending messages between connected users of an address book system, according to some implementations.

FIG. 9 is a schematic diagram illustrating an exemplary operating environment for any of the disclosed implementations.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

One or more techniques or systems may be devised that can allow a user to control what information is available to other user in their address books on a proprietary online-based account platform (“Account Platform”). In one implementation, the one or more techniques or systems may be devised to allow a user to import (e.g., or enter contact information manually) their existing address book's contents operating on a mobile platform operating system, such as an Android, iOS, or Windows based mobile device, into an address book database associated with the Account Platform. Further, in one implementation, the user who has their contacts in the address book may be able to connect with other users of the Account Platform (e.g., a first user can connect with a second, third, and fourth user, etc.). As an example, when two users of the Account Platform “Connect” over the Account Platform, respective users may have the ability to control which items in their user profile are available for display to the other user, in the other user's address book.

As an example, a first user may set up a first user profile in the Account Platform, thereby giving them the ability to store (e.g., link data identified in a database to a data storage location, either locally or remotely) their first user information with the Account Platform, which may include the first user name, mailing address(es), phone number(s), email address(es), internet based voice communication account(s), internet based video communication accounts, and other information. Further, in this example, when the first user establishes an Account Platform connection with a second Account Platform user, the second user can choose which pieces of information, as linked (e.g., stored) with their profile, the first user can see in the first user Account Platform address book, when the first user attempts to access (e.g., looks at) the second user's name within the first user's Account Platform address book. Additionally, in this example, when this type of connection is established, the first user may be able to choose which pieces of information, within the first user profile, the second user can access when the second user attempts to access (e.g., looks up the first user) in the second user's Account Platform address book.

In one implementation, the first user may attempt to connect with other users of the Account Platform (e.g., second, third, and fourth users, etc.) by sending a connection request (e.g., using the Account Platform, email, or any convenient connection means). In another implementation, upon setting up the first user profile, users of the Account Platform that are already in the first user's address book may be automatically (e.g. programmatically) identified, and connection requests can be prepared. In this implementation, the connection requests may be automatically (e.g. programmatically) sent to the identified users of the Account Platform, or the first user may authorize sending of the connection request to one or more of the identified users of the Account Platform in the first user's address book. In another implementation, the first user may send connection requests to “other” connections that are not current users of the Account Platform. That is, for example, the first user can send a request (e.g., using email, the Account Platform, or some other communication) to a connection to connect with them using the Account Platform, such as by creating an account on the Account Platform and importing their contact information.

As an illustrative example, if the first user had an Account Platform connection established with the second user, the first user can choose which phone numbers, email addresses, internet based voice communication profile(s), internet based video communication profile(s), social networking profile(s), etc., that the second user may be able to access (e.g., view) when the second user accesses (e.g., looks at) the first user's name in his Account Platform address book. Further, in this example, the first user can choose which items a third user may access when they attempt to search for (e.g., look up) the first user, when attempting to set up a connection with first user.

In one implementation, a user of the Account Platform (e.g., first user) may wish to change their contact information, such as a phone number or email address (e.g., or any of the other items stored in the first user's profile). In this implementation, upon making such a change, another user of the Account Platform (e.g., second user, third user, etc.) who is accessing the first user's name their Account Platform address book may see merely the updated information, comprising information that the first user has chosen to share with them. Additionally, in this information, the first user may choose to share different types of contact information with different Account Platform users. For example, the first user may wish to share a first phone number with the second user, but not a second phone number; and may wish to share the second phone number with the third user, but not the first phone number (or email addresses, internet based voice communication contact information, internet based video communication contact information, social networking contact information, and other contact information, instant message address, etc.).

In one implementation, when a user accesses their Account Platform address book, they can merely select the phone number made visible to them (e.g., tapping or pressing on the displayed number on a smartphone display), such as on their mobile phone, for example, and by selecting the phone number the smartphone can initiate the dialer and call the number immediately. In one implementation, the user of the Account Platform address book may select an email address, an internet based voice communication address, internet based video communication address, or other information made available to them, for example, and the smartphone can open an appropriate application to perform the requested function, such as opening an email window so that the user can send an email to the email address displayed.

In one implementation, the Account Platform can comprise an application provided on one or more of the many mobile device operating system platforms. In another aspect, the Account Platform can comprise an application provided as an online-based application (e.g., web-app), which may be used on desktop systems, laptop devices, tablets, and any device having a way to access and navigate a network, such as the Internet (e.g., using a web browser).

In one implementation, changes that are made in the mobile-based platform application can be reflected (e.g., automatically, substantially instantly in real time) in the online-based application, such as when the user logs into the web app, for example. As an illustrative example, the web-app may be accessed by navigating the web-browser to a specific Universal Resource Locator (URL), which may automatically (e.g., programmatically) or manually allow the user to open the web-app. In this implementation, the mobile platform application and the online-based application can access the same information, data, edits, etc., as both applications can be operating from a same database (e.g., comprising the address book). For example, respective applications may display the database's information differently, as the mobile platform application is typically displayed on a smaller screen (e.g., smartphone) while the web-app may be displayed on a larger PC, laptop or tablet screen.

In one implementation, the Account Platform (e.g., using one of the applications) can allow users to group some or all of their contacts according to user defined groups (e.g., as many different groups as the user can create). Further, in this implementation, any contact disposed in the address book may be grouped into one or more user created groups. As an example, where a first user contact may comprise a friend that is also a co-worker, the user can group that contact into different groups comprising “Friends” and “Co-workers”. Additional groups may be created or deleted as desired by the user, for example.

In one implementation, a first user of the Account Platform may be able to export their contact information into a second user's Account Platform address book, for example, where the second user meets a set of pre-defined criteria. As one example, a business may wish to make their contact information available to one or more users of the Account Platform, so that the one or more users may contact the business by viewing and selecting the contact information from their address book. That is, for example, the business may wish to access users in a desired demographic (e.g., age group, income range, location, etc.). In this example, the desired demographic information can be cross-referenced against known user information for the Account Platform, and those users within the desired demographic can be identified. Further, in this example, the businesses contact information may be exported to (e.g., or imported into) the identified users' accounts. In this way, for example, instead of typical banner ads, the imported contact information of the businesses may provide a form of advertising to the business's target audience or group of potential customers. Therefore, in this example, businesses who advertise with the Account Platform can, instead of paying for banner ads, have their contact information included in a likely customer's contact list, so that this customer have the option for a pre-defined length of time, of selecting on that business's contact information to contact the business, and hopefully purchase a product or service from the business.

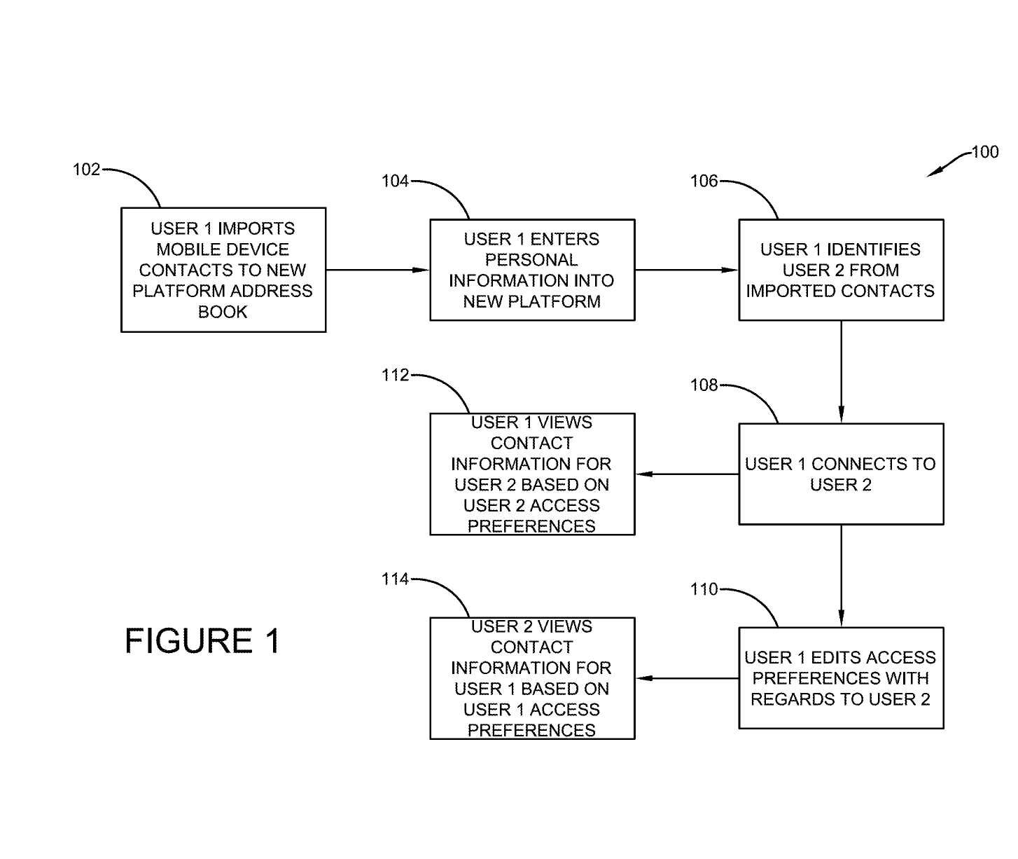

FIG. 1 is a flow diagram illustrating an exemplary method 100 for managing access to contact information in an address book connected with other users in a network. The exemplary method 100 begins at 102, and involves a first user importing their mobile device based contacts (e.g., from their smartphone) into an Account Platform address book. As an example, the first user may have several disparate address books, all of which could be migrated to the Account Platform address book. At 104, the first user can enter their personal contact information into a database operated on the Account Platform, such as their name, address, various phone numbers, email address(es), instant message ids, internet based voice communication address, internet based video communication address, and other information, and other social network contact information. In one implementation, the first user may import their mobile device contacts to the Account Platform address book by manually inputting the appropriate information into the address book. In another implementation, the contacts may be automatically (e.g., programmatically) imported into the Account Platform address book. In another implementation, a combination of automatic and manual importing of contact information may be used by the first user.

At 106, in the exemplary method 100, the first user may identify a second user in their list of contacts who is also a user of the Account Platform. Alternately, the first user may search the Account Platform database for the other users not in the first user's address book, to identify the second user. At 108, the first user can connect with the second user via the Account Platform. At 112, upon connecting, the contact information of the first user may become available for access to the second user, and the contact information of the second user may become available to access to the first user. Here, the second user information available to the first user may be based on the user preferences set up by the second user.

At 110, the first user can edit access rights to the first user's personal contact information, with respect to the second user. That is, for example the first user may identify merely those pieces of personal contact information in their Account Platform address book that they want accessible to the second user. At 114, the second user can view the contact information for the first user, based on the access preferences set up by the first user. In one implementation, the second user may maintain “other” first user related contact information in the second user's address book. That is, for example, regardless of what information the first user allows the second user to access from the first user's address book, the second user may manually maintain other information related to the first user, such as phone numbers, email addresses, etc. In this example, the first user may not be able to control access to this “other” information.

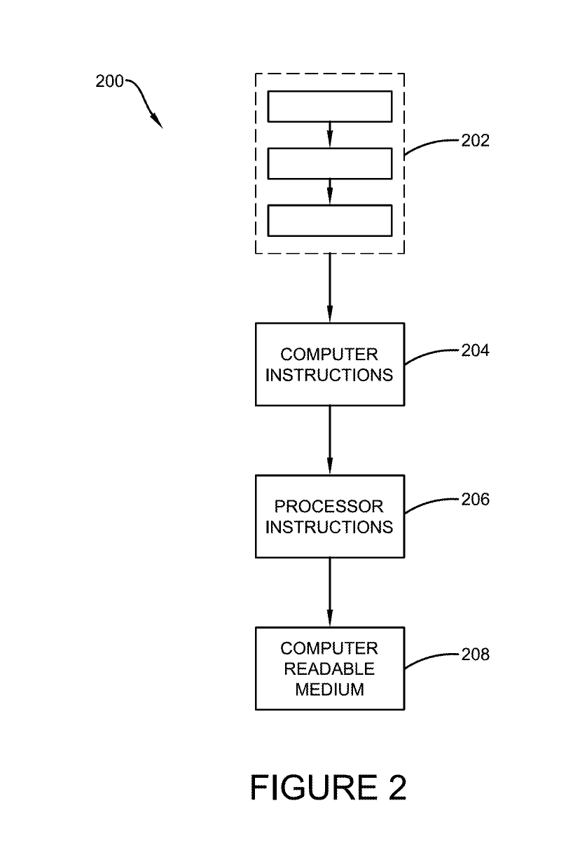

FIG. 2 illustrates an exemplary implementation 200 of a computer-readable medium 208. The computer-readable medium 208 may include processor-executable instructions that can be configured to implement one or more portions of the one or more techniques or systems presented herein. The exemplary implementation 200 includes a computer-readable medium 208 (e.g., a CD-R, DVD-R, a hard disk drive, flash-drive, non-volatile memory storage component), on which is encoded computer-readable data 206. This computer-readable data 206 in turn comprises a set of computer instructions 204 that can be configured to operate in accordance with one or more of the techniques set forth herein. In one such implementation 202, the processor-executable instructions 204 may be configured to perform a method, such as at least some of the exemplary process or method 100 of FIG. 1. In another such implementation, the processor-executable instructions 204 may be configured to implement a system. Many such computer-readable media may be devised by those of ordinary skill in the art that are configured to operate in accordance with the techniques or systems presented herein.

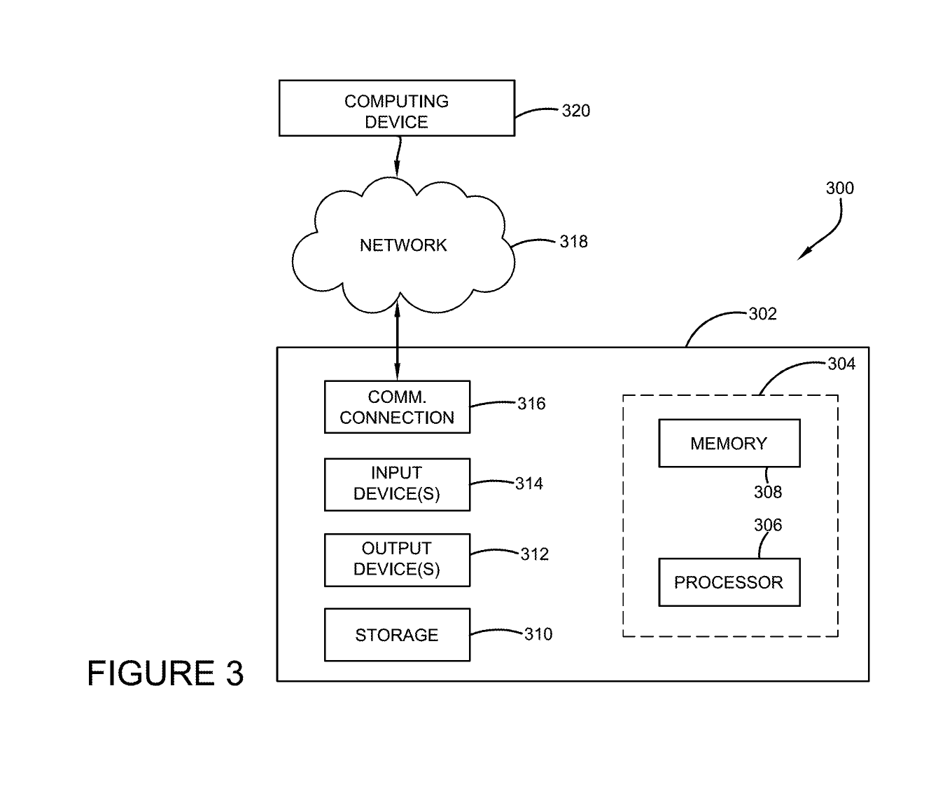

FIG. 3 and the following discussion provide a brief, general description of a computing environment in or which one or more or the implementations of one or more of the methods, techniques, or systems set forth herein may be implemented. The operating environment of FIG. 3 is merely an example of a suitable operating environment and is not intended to suggest any limitation as to the scope of use or functionality of the operating environment. Exemplary computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 3 illustrates an example of a system 300 comprising a computing device 302 configured to implement one or more implementations provided herein. In one configuration, computing device 302 includes at least one processing unit 306 and memory 308. Depending on the exact configuration and type of computing device, memory 308 may be volatile (such as RAM, for example), non-volatile (such as ROM, flash memory, etc., for example) or some combination of the two. This configuration is illustrated in FIG. 3 by dashed line 304.

In other implementations, computing device 302 may include additional features or functionality. For example, computing device 302 may also include additional storage (e.g., removable or non-removable) including, but not limited to, magnetic storage, optical storage, and the like. Such additional storage is illustrated in FIG. 3 by storage 310. In one implementation, computer readable instructions to implement one or more implementations provided herein may be in storage 310. Storage 310 may also store other computer readable instructions to implement an operating system, an application program and the like. Computer readable instructions may be loaded in memory 308 for execution by processing unit 306, for example.

The term “computer readable media” as used herein includes computer storage media. Computer storage media includes volatile and non-volatile, removable and non-removable media implemented in any method or technology for storage of information such as computer readable instructions or other data. Memory 308 and storage 310 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by computing device 302. Any such computer storage media may be part of computing device 302.

Computing device 302 may also include communication connection(s) 316 that allows computing device 302 to communicate with other devices. Communication connection(s) 316 may include, but is not limited to, a modem, a Network Interface Card (NIC), an integrated network interface, a radio frequency transmitter/receiver, an infrared port, a USB connection or other interfaces for connecting computing device 302 to other computing devices. Communication connection(s) 316 may include a wired connection or a wireless connection. Communication connection(s) 316 may transmit and receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Computing device 302 may include input device(s) 304 such as keyboard, mouse, pen, voice input device, touch input device, infrared cameras, video input devices, or any other input device. Output device(s) 312 such as one or more displays, speakers, printers, or any other output device may also be included in computing device 302. Input device(s) 314 and output device(s) 312 may be connected to computing device 302 via a wired connection, wireless connection, or any combination thereof. In one implementation, an input device or an output device from another computing device may be used as input device(s) 314 or output device(s) 312 for computing device 302.

Components of computing device 302 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another implementation, components of computing device 302 may be interconnected by a network. For example, memory 308 may be comprised of multiple physical memory units located in different physical locations interconnected by a network.

Those skilled in the art will realize that storage devices utilized to store computer readable instructions may be distributed across a network. For example, a computing device 320 accessible via network 318 may store computer readable instructions to implement one or more implementations provided herein. Computing device 302 may access computing device 320 and download a part or all of the computer readable instructions for execution. Alternatively, computing device 302 may download pieces of the computer readable instructions, as needed, or some instructions may be executed at computing device 302 and some at computing device 320.

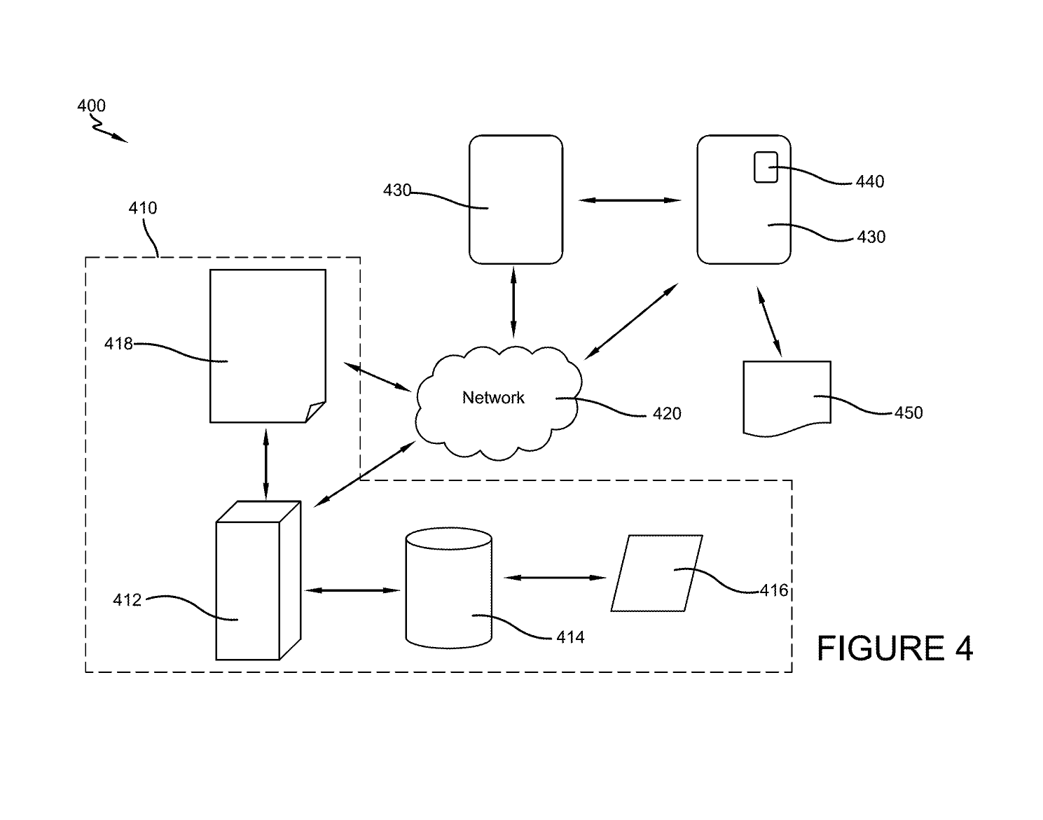

FIG. 4 illustrates an exemplary operating environment 400, according to some implementations. The operating environment 400 may include an address book system 410 (represented by the dashed line), a network 420, and one or more devices 430. The address book system 410 may include a computing device 412, a database 414, one or more address books 416, and a website 418. The computing device 412 may include one or more servers. The computing device 412 may include a communications service or server, which can send communications including, but limited to, emails, text messages, video messages, multimedia messages, RSS or data feeds, or comma delimited output. The computing device 412 may include any necessary hardware and software to host and operate the address book system 410, the database 414, the one or more user address books 416, the website 418, one or more user interfaces, one or more mobile application interfaces, and various other applications. The address book system 410 may store and manage user accounts, login credentials, and one or more user address books 416. The network 420 may include any computer or data network including, but not limited to, the Internet, an intranet, a local area network, a wide area network, or any other network or combination of networks. The website 418 may provide an interface for users to login to the address book system 410 and manage one more user address books 416. The website 418 may be accessed by any device 430 capable of accessing the network 420.

The device 430 may be a cell or mobile phone, including a smartphone, a tablet, a laptop or notebook, a desktop or other personal computer, or any other electronic device capable of accessing the network 420. The device 430 may connect to another device 430 through the network 420 or directly through a wired or wireless connection. The device 430 may include a mobile application or mobile app 440. The device 430 may run a mobile operating system software which provides a platform for mobile apps 440 to operate. The mobile app 440 may allow users of the devices 430 to access the address book system 410 and manage their user address books 416. The device 430 may communicate with the computing device 412 or the database 414 via the mobile app 440, or the device 430 may communicate with the computing device 412 or the database 414 via the website 418 using a web browser. The device 430 may include a contact directory or list 450 with contact information. When the device 430 accesses the address book system 410, the contact list 450 may synchronize with the address book 416. Any updates in the address book 416 may update the contact list 450 on the devices, and any updates to the contact list 450 on the device 430 may update the address book 416.

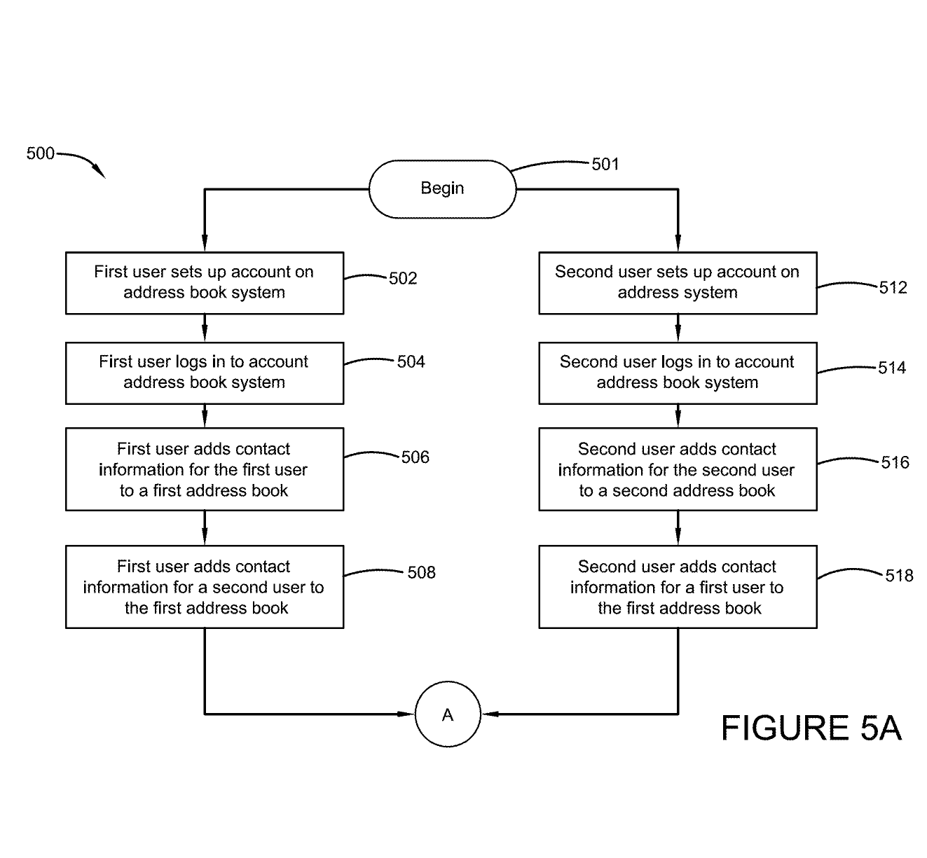

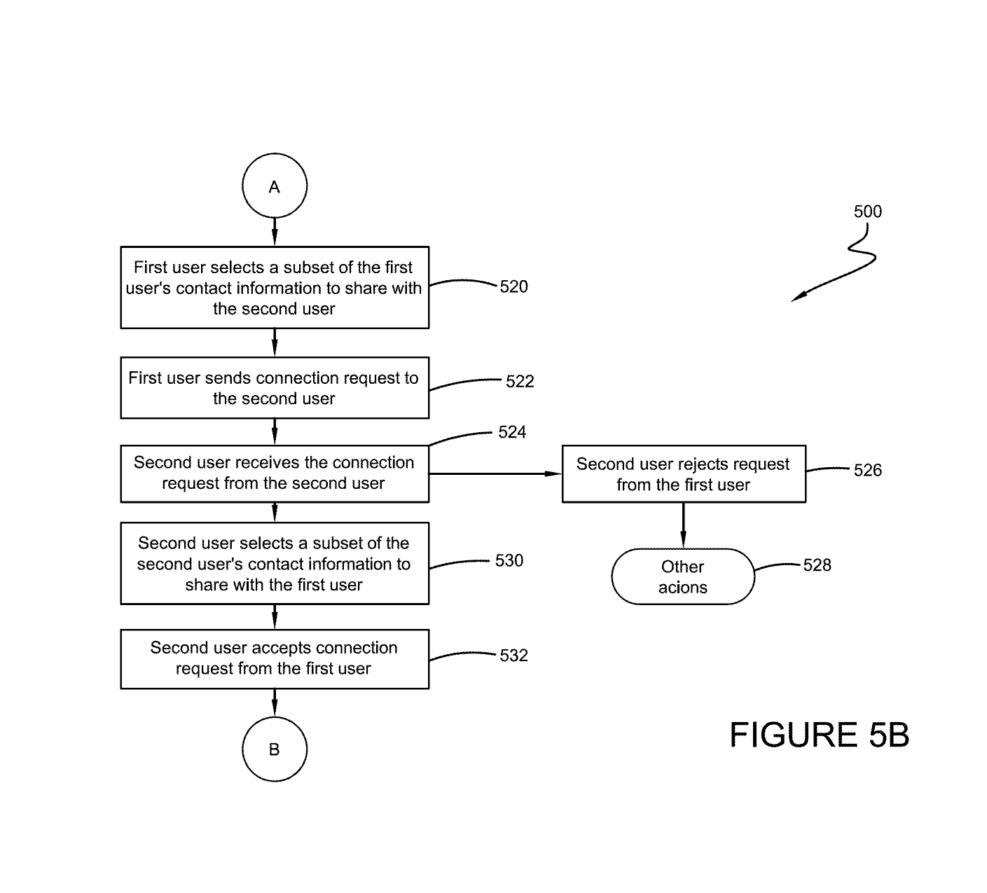

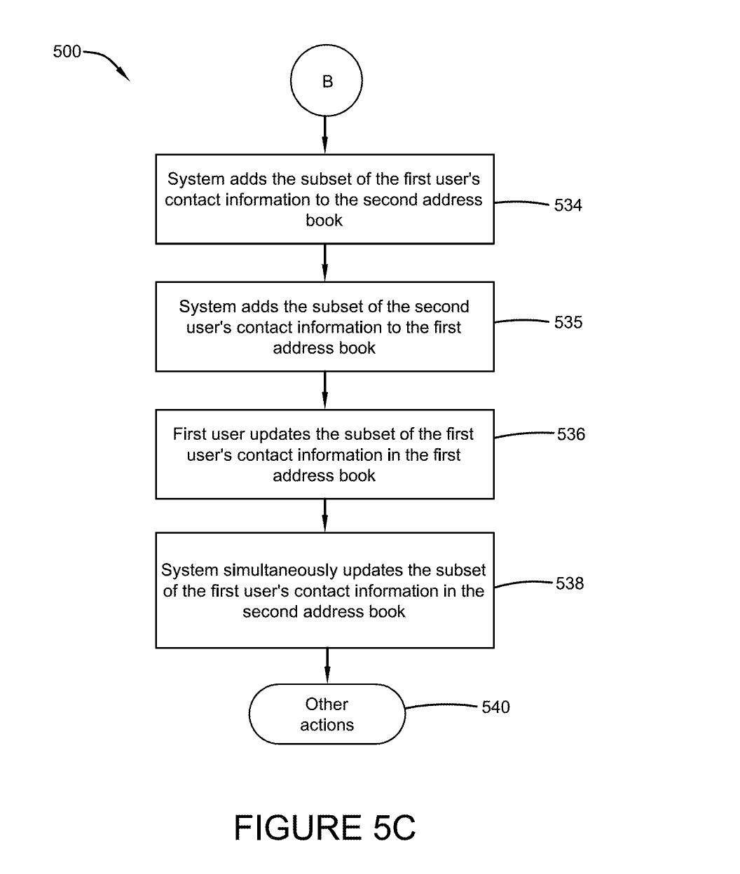

FIGS. 5A, 5B, and 5C show an exemplary method 500 for managing personal contact information between connected or linked users of an address book system, for example, address book system 410 of FIG. 4. At 501, the flow diagram begins. At 502, a first user may setup an account on the address book system, for example, using a unique username and password, via a web browser or mobile app. At 504, the first user may access and login to the first user's account on the address book system, such as, by using the unique username and password, to access and manage a first address book. In some implementations, an email address may be the unique account identifier.

At 506, the first user may add contact information for the first user to the first address book. At 508, the first user may add contact information for a second user to the first address book. The first user may upload contact information for one or more contacts, including contact information for the first user or the second user, to the first address book, for example, from any electronic device capable of communicating with the address book system, for example, device 430 of FIG. 4. As an example, the first user may upload contact information for one or more contacts to an address book from any online or local service or system including, but not limited to, online or local email services or systems.

At 512, a second user may setup an account on the address book system, for example, using a unique username and password, via a web browser or mobile app. At 514, the second user may access and login to the second user's account on the address book system, such as, by using the unique username and password and access and manage a second address book. At 516, the second user may add contact information for the second user to the second address book. At 518, the second user may add contact information for a first user to the second address book.

At 520, the first user may select a portion or subset of the first user's contact information in the first address book to share with the second user. At 522, the first user may send a connection request to the second user. In one implementation, the first user may send a message with the connection request. For example, the first user may send an email or text message with the connection request. At 524, the second user may receive the connection request from the first user. As an example, the second user may also receive the message, email, or text message regarding the connection request. At 526, the second user may reject the connection request from the first user. At 528, other actions, if any, may be performed.

At 530, the second user may select a portion or subset of the second user's contact information in the second address book to share with the first user. At 532, the second user may accept the connection request from the first user. At 534, the address book system may add the first user's contact information to the second address book. In addition, at 535, the address book system may add the second user's contact information to the first address book. As an example, once a connection request has been accepted, the first and second users may be connected or linked within the address book system. In this example, the first user shares a portion or subset of the first user's contact information in the first address book with the second user, which may result in the portion or subset of the first user's contact information in the first address book also being in the second address book. Further in this example, the second user shares a portion or subset of the second user's contact information in the second address book with the first user, which may result in the portion or subset of the second user's contact information in the second address book also being in the first address book.

At 536, the first user may update a portion or subset of the first user's contact information in the first address book. At 538, the address book system may serially, sequentially, consecutively, concurrently, or simultaneously update the portion or subset of the first user's contact information in the second address book. For example, if the first user changes a portion of the first user's contact information in the first address book that is shared with the second user, then the address book system may update the changed portion of the first user's contact information in the second address book. As another example, if the first user changes a portion of the first user's contact information in the first address book that is not shared with the second user, then the address book system may not update the changed portion of the first user's contact information in the second address book. In this implementation, the first and second address books may remain synchronized for the portion or subset of information shared between the first and second users, but the first and second address books may not remain synchronized for the portion or subset of information that is not shared between the first and second users. At 540, other actions, if any, may be performed.

In some implementations, any user may connect with one or more other users and share the same or different contact information with each user. In one implementation, a first user may share a first portion of the first user's contact information with a second user and a second portion of the first user's contact information with a third user, where the first and second portions may include some of the same contact information, all of the same contact information, some different contact information, or entirely different contact information. In one implementation, a first user may share a first portion of the first user's contact information with a second user and a second portion of the first user's contact information with a third user, where the second portion of the first user's contact information is a subset of the first portion of the first user's contact information. In one implementation, the first portion of the first user's contact information may include just a portion or subset of the first user's contact information or substantially all of the first user's contact information.

In some implementations, after a first user shares a portion of the first user's contact information with a second user, the first user may decide to stop sharing all or some of the shared portion of the first user's contact information with the second user. For example, the first user may select one or more portions of the first user's contact information to stop sharing with the second user, which may result in the removal of the one or portions of first user's contact information from the second user's address book.

In addition, in one implementation, after a first user shares a portion of the first user's contact information with a second user, the first user can decide to share additional portions of the first user's contact information with the second user. For example, the first user may select one or more additional portions of contact information to share with the second user, which may result in the addition of the one or more additional portions of first user's contact information in the second user's address book.

Alternatively, in one implementation, the first user may decide to stop sharing all information with a second user. For example, the first user may unselect the second user, which may result in the removal of the shared portions of first user's contact information from the second user's address book. As another example, if the second user had additional contact information for the first user, in addition to the contact information shared by the first user, that additional contact information may remain in the second user's address book.

Once a first user has setup an account on the address book system, the first user may access and manage contact information for one or more contacts in a first address book. The first user may add one or more contacts to the first address book with each contact comprising contact information. The contact information may include one or more telephone numbers, one or more email accounts, one or more addresses (e.g., home address, work address, vacation address, etc.), one or more websites, one or more social media sites, one or more communication services, etc.

When the first user accesses the address book system via a computing device, the contact information on the computing device is synchronized with the contact information in the first address book on the address book database. Any updates in the first address book may update the contact information on the computing device, and any updates to the contact information on the computing device may update the first address book.

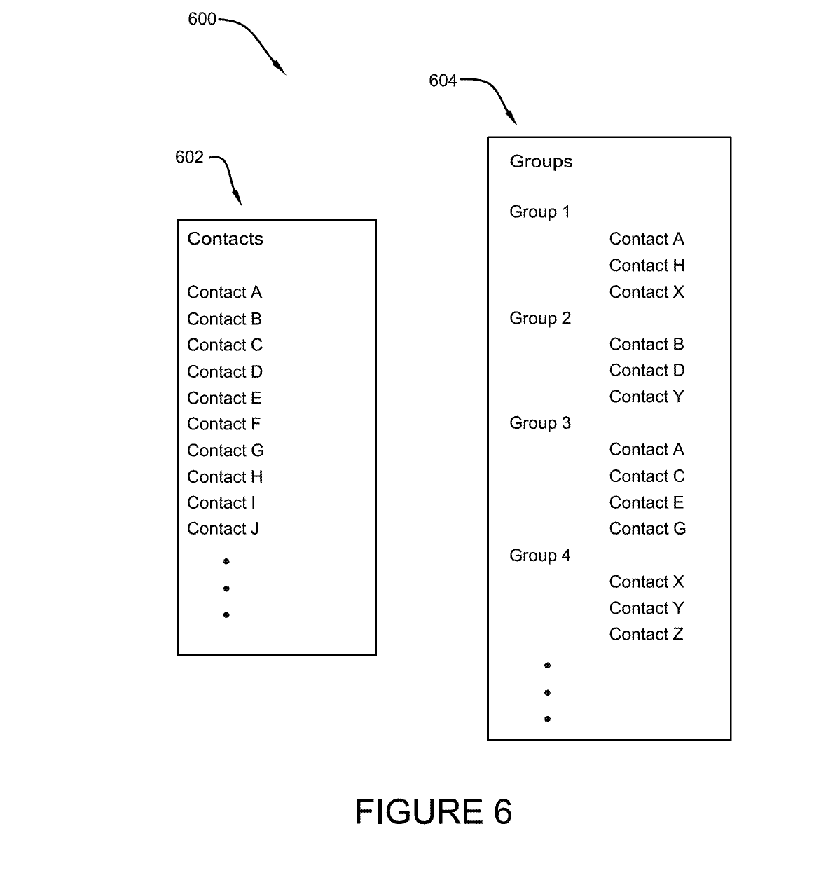

FIG. 6 shows an exemplary listing of contacts and groups. The address book system may include one or more methods, techniques, or systems for organizing contacts and contact information within an address book. A list of contacts for a user may be organized in alphabetical order by first or last name. For example, a contact directory 602 may list the contacts in an address book in alphabetical order by first or last name. A list of contacts for a user may be organized into one or more groups. The list of contact may be organized in alphabetical order within each group. For example, a group directory 604 may include a list of groups in alphabetical order and may also list the contacts in each group in alphabetical order. The address book system may include one or more groups, for example, a user may be able to add or create one or more groups. A user may place a contact into one or more groups. For example, a user could place a first contact into a “Work” or “Co-worker” group, a second contact into a “Friends” group and a “Family” group, and a third contact into a “Client” group. Users may add or create as many groups as they desire and may place each contact into as many groups as they desire.

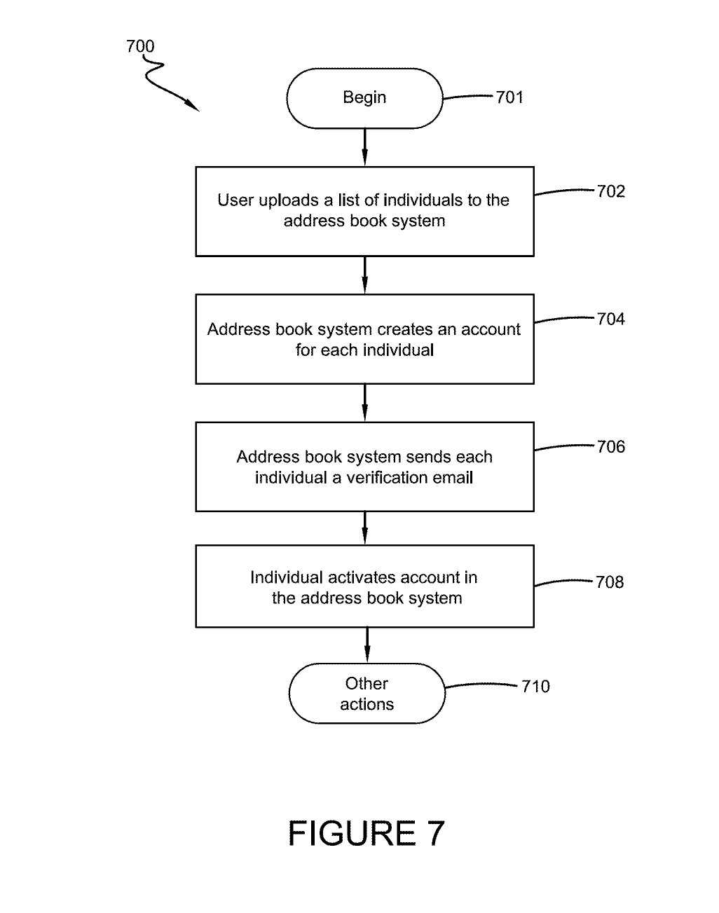

FIG. 7 shows an exemplary method 700 for adding multiple contacts to the address book system. At 701, the flow diagram begins. At 702, a user may upload a list of individuals to be added to the address book system. The list of individuals may include first and last names and an email address, or other contact information, for each individual. At 704, the address book system creates an account for each individual. At 706, the address book system sends each individual a verification message (e.g., email), which may include a verification link within the message. At 708, an individual may activate the individual's account in the address book system, for example, by selecting a link in an email or other message. At 710, other actions, if any, may be performed.

In some implementations, the address book system may include a mass account creation system. As one example, the mass account creation system may use a list of company's employees to generate new user accounts for each employee. In this example, the list of employees may include each employee's first and last name and email address, or other contact information. When an employee would logins to the address book system for the first time, they may already have an account established. The mass account creation system may send an email to each employee, who would complete the activation process to create the user account on the address book system.

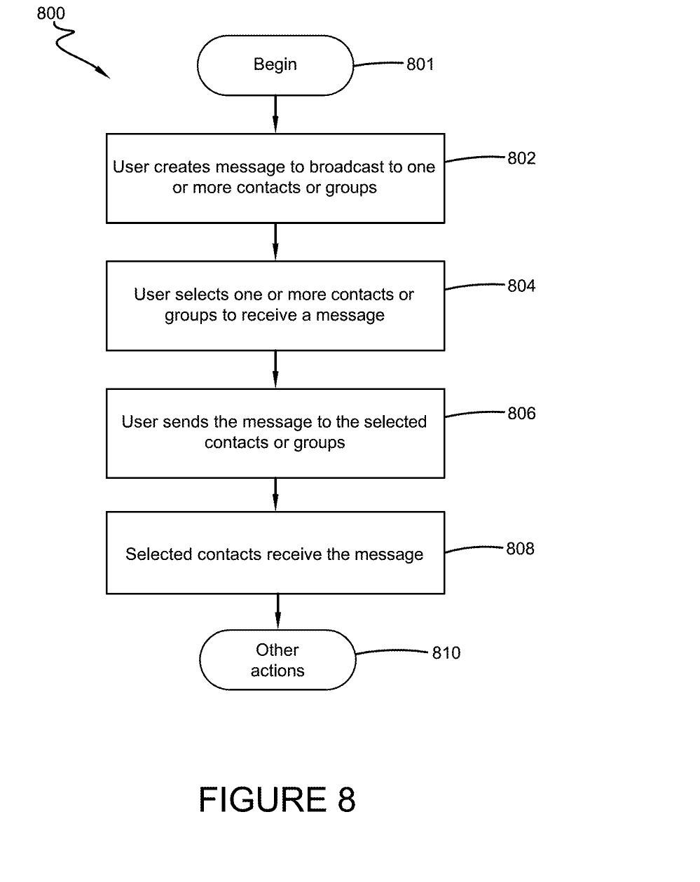

FIG. 8 shows an exemplary method 800 for sending a message to one or more contacts in the address book system. At 801, the flow diagram begins. At 802, a user may create a message to broadcast to one or more contacts or groups. At 804, the user may select one or more contacts or one or more groups to receive a message. At 806, the user may send the message to the selected contacts or groups. At 808, the selected contacts receive the message. At 810, other actions, if any, may be performed.

In some implementations, the address book system may include a messaging system to send messages to one or more users. A first user could send or broadcast a message to one or more users of the address book system. A first user could send or broadcast a message to one or more users in the first user's contact list or to one or more users with whom the first user is connected. A user could send or broadcast a message to one or more groups created by the user. The message could include a text message, a voice message, a video message, or any combination of the preceding. The message can include text, emoticons, images, videos, or recorded voice or video messages. Each user may select what types of messages to receive and how the messages are received. If a user has multiple email addresses or telephone numbers, the user could select which contact points, if any, may receive messages. The messaging system may include the ability to initiate telephone calls between users or groups of users, or with anyone else including non-users.

According to some implementations, the address book system may include a game system. The game system may include any multi-player game. A user of the address book system can play against the user's contacts, or connected users, or a virtual user. The games may include timed moves to keep a game progressing and prevent it from becoming stale. A user can invite contacts or groups to play a multi-player game. The game system could include a leaderboard within each user group showing which user has earned the most points. The points may be used to make purchases within the address book system or redeem for online gift cards or prizes.

According to some implementations, the address book system may include a status indicator for connected users. A user could see the status of any contact, or connected user. For example, a contact's status could be online, offline, busy, away, etc. The address book system could set the status of each user, and each user could update his or her status. Users can set their status to unknown.

According to some implementations, the address book system may include a location feature for users. When a user profile is accessed, the address book system could provide information about the user's location, or nearby areas, including weather, sports, news, etc.

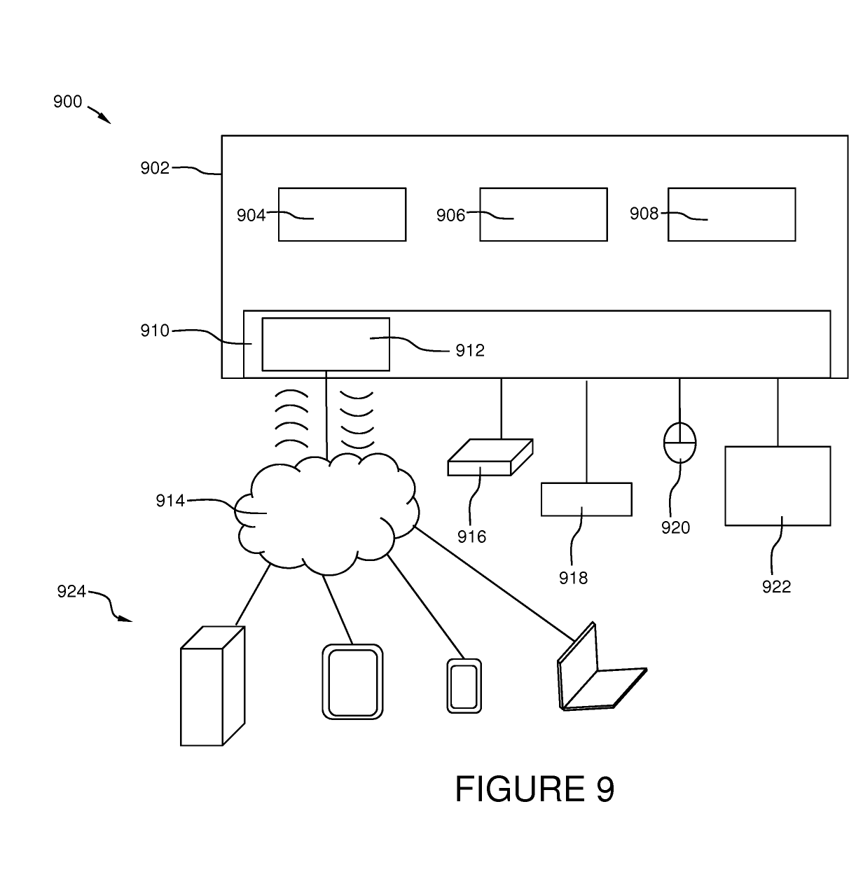

FIG. 9 shows an exemplary operating environment 900 for any of the disclosed implementations. Any of the methods, techniques, or systems described herein may be performed with a digital processing system, such as a conventional, general-purpose computer system. Alternatively, special purpose computers, which are designed or programmed to perform only one function, may be used. The computer system 902 may include a processor 904 coupled through a bus to a memory 906, a permanent storage 908, and an input/output (I/O) interface 910. The permanent storage 908 represents a persistent data storage device such as a hard drive or a USB drive, which may be local or remote. A network interface 912 may provide connections via network 914, allowing wired or wireless communications with other devices or networks. The processor 904 may be embodied in a general-purpose processor, a special purpose processor, or a specially programmed logic device. The input/output (I/O) interface 910 may provide communication with different peripherals and may be connected with the processor 904, the memory 906, and the permanent storage 908, through the bus. Exemplary peripherals may include a display 922, a keyboard 918, a mouse 920, a removable media device 916, or other peripherals. The display 922 may be configured to display any of the user interfaces described herein. The keyboard 918, mouse 920, removable media device 916, and other peripherals may be coupled to the I/O interface 910 in order to exchange information with processor 904. Data to and from any devices 924 may be communicated through the I/O interface 910.

Some implementations may be practiced in distributed computing environments where tasks are performed by remote processing devices that are linked through a wired or a wireless network. Some implementations may be fabricated as computer readable code on a non-transitory computer readable storage medium. The non-transitory computer readable storage medium holds data which can be read by a computer system. Exemplary non-transitory computer readable storage medium include permanent storage 908, network attached storage (NAS), read-only memory or random-access memory in memory module 906, optical discs, flash drives, hard drives, magnetic tapes, and other data storage devices. The non-transitory computer readable storage medium may be distributed over a network-coupled computer system so that the computer readable code is stored and executed in a distributed fashion. Various types of devices 924 may connect to the network 914, for example the internet. The devices 924 may include servers, tablet computers, cell or mobile phones including smartphones, laptops, desktops, and other electronic devices. The various devices 924 may run various operating systems, which may depend upon the device manufacturer. One or more, or all, operations of any of the methods, techniques, or systems presented herein may be executed through a processor, such as processor 904. Although the method operations were described in a specific order, some operations may be performed in a different order, when the order of the operations does not affect the expected results. In any of the methods presented, other operations may be included, which may be performed by different entities in a distributed fashion, so long as the processing of the operations is performed in the desired manner or method.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program or a computer. By way of illustration, both an application running on a controller and the controller can be a component. One or more components may reside within a process or thread of execution and a component may be localized on one computer or distributed between two or more computers.

Furthermore, the claimed subject matter may be implemented as a method, apparatus or article of manufacture using standard programming or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A computer implemented method for managing personal contact information between connected users of an address book system, comprising:
adding a first user's contact information to a first address book in an address book database;
adding a second user's contact information to a second address book in the address book database;
selecting a first subset of the first user's contact information in the first address book to share with a second user;
receiving data indicative of a connection request being sent from the first user to the second user;
selecting a second subset of the second user's contact information in the second address book to share with the first user;
receiving data indicative of an acceptance of the connection request by the second user;
adding the first subset of the first user's contact information from the first address book to the first user's contact information in the second address book;
adding the second subset of second user's contact information to the second user's contact information in the first address book.

2. The computer implemented method of claim 1, further comprising:
updating the first subset of the first user's contact information in the first address book;
updating the first subset of the first user's contact information in the second address book.

3. The computer implemented method of claim 1, further comprising:
identifying a third user in the address book system based at least upon a user based search by the first user.

4. The computer implemented method of claim 3, further comprising:
selecting a third subset of the first user's contact information in the first address book to share with the third user;
receiving data indicative of a connection request being sent from the first user to the third user;
selecting a fourth subset of the third user's contact information in the third address book to share with the first user;
receiving data indicative of an acceptance of the connection request by the third user;
adding the third subset of the first user's contact information from the first address book to the first user's contact information in the third address book;
adding the fourth subset of third user's contact information to the third user's contact information in the first address book.

5. The computer implemented method of claim 1, further comprising:
receiving data indicative of a contact list being uploaded from a device for the first user;
selecting a contact from the contact list;
sending data indicative of a connection request being sent to the contact.

6. The computer implemented method of claim 1, further comprising:
receiving data indicative of a removal of a portion of the first subset of the first user's contact information shared with a second user;
removing the portion of the first subset of the first user's contact information from the second address book.

7. The computer implemented method of claim 1, further comprising:
receiving data indicative of an unselection of the second user from sharing the first user's contact information;
removing the first subset of the first user's contact information from the second address book.

8. The computer implemented method of claim 1, further comprising:
receiving data indicative of an addition of information to the first subset of the first user's contact information shared with a second user;
adding the additional of information to the first subset of the first user's contact information in the second address book.

9. A system comprising:
one or more processors; and
a memory comprising instructions that, when executed by the one or more processors, cause the one or more processors to:
create a first address book with first contact information for a first user;
create a second address book with second contact information for a second user;
select a subset of the first contact information;
receive data indicative of a connection request begin sent from a first user to a second user;
select a subset of the second contact information;
receive data indicative of an approved connection request being sent from the second user to the first user;
add the subset of the second contact information to the first address book;
add the subset of the first contact information to the second address book.

10. The system of claim 9, wherein the memory comprising instructions that, when executed by the one or more processors, cause the one or more processors to:
update the first subset of the first user's contact information in the first address book;
update the first subset of the first user's contact information in the second address book.

11. The system of claim 9, wherein the memory comprising instructions that, when executed by the one or more processors, cause the one or more processors to:
identify a third user in the system based at least upon a user based search by the first user.

12. The system of claim 9, wherein the memory comprising instructions that, when executed by the one or more processors, cause the one or more processors to:
receive data indicative of a removal of a portion of the first subset of the first user's contact information shared with a second user;
remove the portion of the first subset of the first user's contact information from the second address book.

13. The system of claim 9, wherein the memory comprising instructions that, when executed by the one or more processors, cause the one or more processors to:
receive data indicative of an unselection of the second user from sharing the first user's contact information;
remove the first subset of the first user's contact information from the second address book.

14. The system of claim 9, wherein the memory comprising instructions that, when executed by the one or more processors, cause the one or more processors to:
receive data indicative of an addition of information to the first subset of the first user's contact information shared with a second user;
add the additional of information to the first subset of the first user's contact information in the second address book.

15. A non-transitory computer readable storage medium storing computer executable instructions for sharing personal contact information between connected users of an address book system, the instructions comprising:
creating a first address book with first contact information for a first user;
creating a second address book with second contact information for a second user;
selecting a subset of the first contact information;
receiving data indicative of a connection request being sent from a first user to a second user;
selecting a subset of the second contact information;
receiving data indicative of an approved connection request being sent from the second user to the first user;
adding the subset of the second contact information to the first address book;
adding the subset of the first contact information to the second address book.

16. The non-transitory computer readable storage medium of claim 15, the instructions further comprising:
updating the first subset of the first user's contact information in the first address book;
updating the first subset of the first user's contact information in the second address book.

17. The non-transitory computer readable storage medium of claim 15, the instructions further comprising:
identifying a third user in the address book system based at least upon a user based search by the first user.

18. The non-transitory computer readable storage medium of claim 15, the instructions further comprising:
receiving data indicative of a contact list being uploaded from a device for the first user;
selecting a contact from the contact list;
receiving data indicative of a connection request being sent to the contact.

19. The non-transitory computer readable storage medium of claim 15, the instructions further comprising:
receiving data indicative of a removal of a portion of the first subset of the first user's contact information shared with a second user;
removing the portion of the first subset of the first user's contact information from the second address book.

20. The non-transitory computer readable storage medium of claim 15, the instructions further comprising:
receiving data indicative of an addition of information to the first subset of the first user's contact information shared with a second user;
adding the additional of information to the first subset of the first user's contact information in the second address book.
